(19) United States
(12) Patent Application Publication
(10) Pub. No.: US 2001/0032166 A1
(43) Pub. Date: Oct. 18, 2001

(54) System and method for planning and tracking the manufacture of tooling for machinery

(76) Inventors: Thomas J. Ruffo, San Jose, CA (US); Michael Romaine, Suwanee, GA (US)

Correspondence Address: NIXON & VANDERHYE P.C., 8th Floor, 1100 North Glebe Road, Arlington, VA, 22201, US

(21) Appl. No.: 09/749,288

(22) Filed: Dec. 28, 2000

Related U.S. Application Data
(60) Provisional application No. 60/192,552, filed on Mar. 28, 2000.

(51) Int. Cl. G06F 17/60

(52) U.S. Cl. 705/37; 700/160

(57) ABSTRACT

A purchasing order system has been developed for tool requisitioning. The system is computer based and comprises a computer network with computer terminals, databases and external communication such as via the Internet and email. The system includes remotely-accessible databases having information regarding tooling vendors, templates for purchase orders, electronic drawings of tooling, and information regarding on-going and past tooling requisitions.

### BACKGROUND OF THE INVENTION

The present invention relates to the field of computerized organizational and tracking systems for procurement and acquisition operations, as for example, the fabrication of tooling by outside vendors.

### DESCRIPTION OF PRIOR ART

Tooling for manufacturing machinery is often custom made by outside vendors that fabricate tools made to order. A manufacturer prepares a drawing and specification of a tool to be custom made by a machine shop or other vendor. The tool drawings and specification are incorporated in a request for quotation that is sent to one or more selected vendors. The vendors bid on proposals for new tooling. One of the tool bids is selected, such as the low-cost bid, and a purchase order (P.O.) is awarded to the vendor that submitted the selected bid. That vendor fabricates the tool and delivers it to the manufacturer.

The tool requisitioning process generally starts by an engineer or mechanic (the “requester”) who designing a new tool to be built or needs another existing custom-made tool. The tool has to be described and defined in engineering drawings, specifications, computer aided design and computer aided manufacturing (CAD/CAM) instructions and/or other formats (collectively referred to here as “tool drawings”) that can be used by a tool vendor to make the tool. Once the drawings for the tool have been prepared by the requester (or selected from a previous tooling order), the requester contacts a buyer in the purchasing department for his company to actually order the tool. Generally, the buyer is a different person than the tool requester and is skilled in the requisitioning process. The buyer prepares the quote request(s); contacting vendors to bid of the tool in response to the quote requests; selects a winning quote, issues P.O.s (which are contracts binding on the company); tracks issued P.O.s and confirms that the tools are delivered in a timely and satisfactory fashion; and arranges to pay the vendor for the tool fabrication. This requisitioning process has been in the past a paper intensive and a non-automated process.

The requisitioning tool process is prone to delay, error and confusion, at least in part, because it is paper intensive and is not automated. For example, the tool drawings are one source of this delay, error and confusion. The tool drawings are copied and recopied on photocopiers so that drawing copies can be attached to quote requests and P.Os. Often copies of the tool drawings are sent by facsimile to vendors. The tool drawings have a tendency to become distorted or illegible during the photocopying and faxing processes. To respond to a quote request, vendors have had to request additional copies of the drawings that are hopefully clear and legible, or prepare tool quotes based on illegible and/or distorted drawings. Having tooling vendors bid based on illegible drawings is one source of error and confusion in the requisitioning process.

Another source of delay and miscommunication occurs between the in-house buyer and requester, i.e., the engineer or mechanic who requested the tooling. A miscommunication between the buyer and requester will delay the issuance of the requests for quotations, cause errors in the quote requests, and necessitate that the requester and buyer revise the quote request or P.O., once the error caused by a miscommunication is discovered. In addition, the process is delayed if the buyer and/or requester do not promptly follow-up with the generation of purchase orders and subsequent procurement activity.

Distribution of requests for quotations by the buyer to prospective vendors is also prone to delay and confusion. For example, a photocopy of the entire purchase order, including drawings of the tool, must be prepared for each vendor. The proposal must be shipped to the vendor either by facsimile, overnight delivery service, mail or other method of conveying the purchase order to each vendor. The simple act of photocopying each of the purchase orders with drawings leads to problems including illegible photocopying and faxing of drawings and purchase orders, incomplete copying of purchase order and drawings, lost purchase orders during delivery and purchase orders being ignored by vendors because they were delivered to vendors when authorized vendor employees were not available to review the proposal.

The preparation of vendor bids in response to purchase orders is also prone to delay and difficulty. Vendors may request duplicate or better copies of the purchase order and tool drawings to properly bid on the purchase order. Accordingly, a purchase order which has been expedited by being faxed to vendors may be delayed because drawings have to be sent by overnight courier so that the vendors may properly respond. Alternatively, the vendors may attempt to bid on tooling using illegible and/or incomplete purchase orders. Vendors that make bids based on incomplete or illegible purchase orders run the risk of under-bidding or over-bidding the purchase order. In addition, a vendor using illegible and/or incomplete drawings may produce an inadequate tool which does not comply with the actual drawings for the tool. The requisitioning process may also be delayed because vendors must have to physically go to their shop where the requests for quotation has been received to prepare a bid on the tool order.

The buyer must wait until the vendors bid in respond to the request for quotations or until a bid deadline passes. While the vendors are evaluating the request, the buyer may need to answer vendor questions regarding the purchase order. To answer these questions, the buyer may need to contact the requester who originally designed and/or needs the tool. The questioning and bid evaluation process further delays procurement process as each of the individuals involved must speak or otherwise correspond to other individuals to move the procurement process along.

Once the vendors have submitted bids, the buyer for the company selects a bid and issues a P.O. to the vendor who submitted the winning bid to build the tool. The selected vendor, upon receipt of the P.O., begins to fabricate the requested tool in accordance with the drawings and specification in the purchase order. The buyer responsible for the purchase order tracks the progress of the tool order by communicating with the vendor to determine the status of the tooling request. If the vendor does not deliver a tool by a delivery date specified in the purchase order, the buyer often telephones the vendor to determine the status of the tool order.

In addition, buyers typically do not have sophisticated software systems that track orders, and may only have their software calendars, address books and project management software programs for assistance. Thus, the buyers must actively track each purchase order and selected vendor for which they are responsible. Moreover, the requester, who designed the tool and may actually use the tool, has limited ability to determine the status of his tool order. Specifically, the requester is often required to contact his buyer who in turn will contact the vendor to determine the status of a tool order.

A better requisitioning process is needed for custom order tools and other products (and services) that are requisitioned by a competitive bid process. Specifically, there is a need to automate and streamline the process of generating tool requests, requests for quotations and purchase orders; selecting vendors; distributing quotation requests and purchase orders to vendors; evaluating and selecting vendor bids; tracking the progress of vendors who fabricate the tools, and tracking the delivery of tools. It would also be desirable to reduce the need for humans to write and rewrite original documents in the requisitioning process, so as to minimize the potential delays caused by human interactions. Furthermore, it would be desirable to regularly track the status of tooling orders to determine when tool orders have been completed, to make that tracking information available to requesters and buyers, to collect data regarding tool orders for future use such as to evaluate vendors, and for other purposes.

### SUMMARY OF THE INVENTION

An automated requisitioning system has been developed for procurement of custom order products and services, e.g., tools. The system enables a tool requester to prepare an order request and attach tool drawings electronically to the request. The request is automatically routed to a buyer (also known as a reviewer) who selects vendors to receive the request to fabricate the tool, and generates a quotation request from the tool request information electronically captured from the request and stored by the system. The quotation requests are electronically transmitted to the selected vendors, with the tool drawings as an attachment (or with an Internet hyperlink to the drawings). The bids submitted by the vendors are entered into the system and the buyer selects one of the vendors to fabricate the tool based on the bids. A purchase order is generated and transmitted to the winning vendor, who fabricates a tool and delivers it to the buyer. Each step of the requisition process is tracked by the system. Moreover, the system facilitates the process by storing information pertinent to the process and automating the generation of tool requests, quotation requests and purchase orders.

The system is computer based and comprises a computer network with computer terminals, databases and external communication such as via the Internet and email. The system includes remotely-accessible databases having information regarding tooling vendors, templates for purchase orders, electronic drawings of tooling, and information regarding on-going and past tooling requisitions.

In an exemplary embodiment, the system is an Outage Tooling System (OTS) for ordering the manufacture of tools by outside machine shops and other vendors. An individual requester desiring to have a tool made accesses the OTS system via a computer terminal to enter in a request for a purchase order. The OTS presents the requester with a series of computer screens that allows the requester to generate a tool request, and automatically create an electronic folder for the tool drawings. For each tool request, the OTS system automatically generates tracking numbers.

Once the tool request has been generated, it is reviewed by buyers who confirm that the tool request is complete and authorized. In addition, the system checks whether the tool requested has been previously fabricated and, if so, identifies the vendor who previously made the tool. The buyer determines whether a sole-source purchase order should be issued (such as submitted solely to the vendor who previously made the same tool design) or if the tool requisition order should be the subject of competitive bids. In either event, a request for a quotation on the tool is generated by the OTS system which exports data from the tool request and formats it into a tool request for quotation email, including an attachment of the tool drawings. The requests for quotations are transmitted to selected vendors via electronic transmission means, such as email over the Internet.

In addition, the tool requester is kept informed by emails generated by the OTS System regarding the distribution of the purchase order to vendors. The requester receives electronically, copies of the email communications between the buyer and vendors. The vendors benefit in several ways by receiving email quote requests and purchase orders. First, the vendors have instant notification of quote requests and purchase orders, and can receive those requests and purchase orders via email at any location from which the vendor has access to the Internet. Thus, vendors who are traveling and away from their manufacturing facility may still receive quote requests and prepare appropriate responses to those purchase orders without ever having to return to their manufacturing facility. Moreover, the vendor may communicate with their manufacturing facility to obtain information for a response to the purchase order by copying the purchase order by email to their manufacturing facility.

In addition, vendors benefit by having electronic copies of the purchase order and tooling drawings. These electronic copies have better resolution than do drawings transmitted by facsimile or photocopied and transmitted by courier or mail. Moreover, the electronic copies allow the vendors to print out accurate and complete tooling copies in as many copies as needed by the vendor, without having to worry that second, third and fourth generation photocopies will render those drawings illegible.

The vendors are able to submit their bids by email to the OTS. The vendor emails are logged into the OTS system. The OTS system tracks which vendors have submitted bids, and when those bids have been received and collects vendor information, such as name, contact information, rate schedule for tooling operations, bid quotes, and tooling capability from the submitted bids. The OTS allows the buyer to quickly review all submitted bids from vendors to select one tooling vendor, such as low-cost bidders, to receive the contract for the purchase order and construct the tool.

The OTS, automatically quires the database nightly to determine what jobs are due in the future. A pre-selected time (that can be changed) such as 3 days, will automatically send e-mails to vendors who's due dates are approaching in the next three days. A report is also generated and e-mailed to the Buyer nightly listing which vendors and release numbers are approaching a due date for delivery of tooling.

In addition, the OTS allows the buyer and requester to monitor the completion of the purchase order contract and to be automatically notified when the tool is delivered. The OTS provides email notification to the Buyer and/or the requester when the tool has been delivered and received by the company operating the OTS system. In addition, the OTS maintains information regarding the completed tool, including such information as cost of the tooling manufacturer, comparison of actual cost versus dollars quoted for the tooling, timeliness of completion of tooling, quality of tooling and services provided by vendor, and other information which may be collected by the OTS system.

Accordingly, the present OTS system provides an easy to use, reliable and comprehensive tooling requisitioning system. The system has been developed using Six Sigma methodologies and Poka-Yoke approaches to provide a requisitioning system which functions reliably and efficiently to order tooling. In addition, the OTS system provides automatic and relatively error-free updating of record file information relevant to the tooling acquisition process, including information regarding the vendors of tools, pending purchase orders, delivery of tools and other information.

The OTS system allows an individual tool requester to step through, in an orderly fashion, the requisition process so as to generate a purchase order, monitor the distribution of purchase orders to vendors, initiate a bidding process by vendors on the tooling, select a winning vendor bid, and track the delivery of a completed tool. The requester is kept informed automatically by email during each step of this requisitioning process. Moreover, as data is entered during the requisition process, the OTS system retains the information for future use, such as for tool cost auditing and control, evaluation of vendors and tools, and other purposes. Furthermore, the data is easily entered into the system by the requester and/or buyer using computer screen templates that prompt each of these individuals to enter correct information that is useful for the requisitioning system, and to inform the data entry person if an error has occurred during data entry.

The OTS system is a resource based purchasing order system. OTS was designed to minimize purchasing errors by incorporating Six Sigma methodologies. The use of e-mail and the Internet by the OTS system facilitates communication transactions between the buyers and requesters within a company, and outside vendors throughout the world who supply products and services to the company. Specifically, the use of e-mail and the Internet to transfer quotes, tool drawings and P.O. authorizations (or to post those documents electronically on a secure company website) are all electronic communications and, thus, are instantaneous, secure (especially if encryption is employed of email messages), clear and impervious to being lost. Moreover, the requester of the tool (or other product or service) is kept advised of the status of the tool order throughout the procurement process.

Several benefits of the OTS system include:

1. Requisition entry of tool orders, quotation requests and purchase orders (P.O.) through easy to understand computer screen templates.

2. Automatic generation of tracking numbers and drawing directories for each tool request, quotation request and purchase order.

3. Date and time stamp functions of requests for tools, quotation requests and P.O.s, using the automatic e-mail capabilities of OTS.

4. Automatic searches for previously built tool jobs to identify existing tool, low cost vendors to make such tools, and facilitate quick re-order placement for previously fabricated tools.

5. Instant notification by e-mail to requester the status of tool requests, quotation requests, and P.O.s. For example, there is instant notification by e-mail (or website posting) of the tool requester and tool buyer of procurement information, such as which vendors have submitted quotations for a tool, which vendor was awarded a P.O. to fabricate a tool, and tool delivery dates.

6. Information regarding vendors is readily displayed via screen templates that show the vendor's name, contact, phone fax, pager, e-mail address, and hyperlink to vendor's web site; Purchase Order(s) awarded to the vendor; vendor's rate schedule, and capability information regarding the vendor, such as tool fabrication equipment and personnel.

7. The OTS databases may be searched via a search screen that presents multiple search criteria (and wild card functions) for fast retrieval of tool procurement information stored in the OTS.

8. A quote information screen shows tool orders in both cost per unit and total cost quoted by vendor for the tool item order.

9. Receiving and invoice screens with automatic e-mail functions to notify the tool requester when a tool is received and is ready for pick-up.

10. Standard reports are generated using conventional database and reporting features.

11. Accounting reports can be generated to show dollars spent for one or more tool P.O.s, dollars quoted for a tool and/or by a vendor, and dollars allocated for tools but not yet paid.

### BRIEF DESCRIPTION OF THE DRAWINGS

FIG. 1 is a schematic diagram which generally shows the operation and structure of an exemplary outage tooling service;

FIG. 2 is a detailed schematic diagram of the computer system and software processes supporting the outage tooling service;

FIGS. 3 to 6, 9, 10 and 12 are exemplary screen displays generated by the outage tooling service;

FIG. 7 is exemplary reports generated by the outage tooling service; and

FIGS. 9, 11, 13 and 14 are exemplary email messages generated by the outage tooling service.

### DETAILED DESCRIPTION OF THE INVENTION

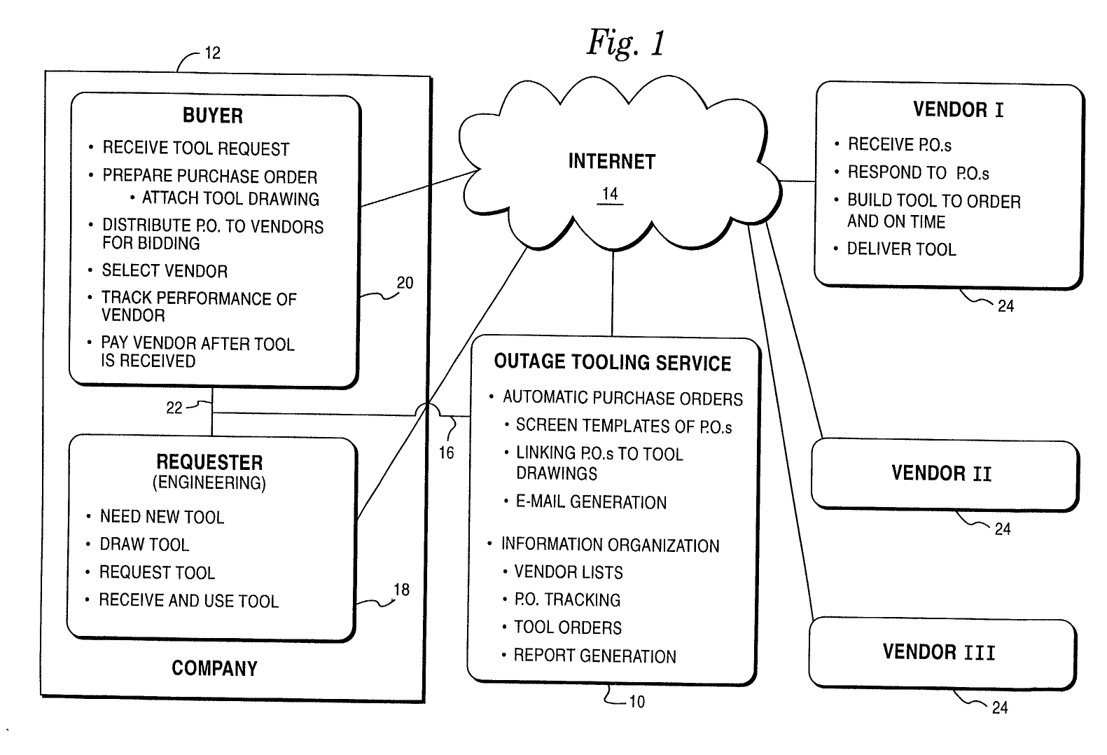

FIG. 1 shows schematically an overview of an exemplary outage tooling service (OTS) system 10 which provides automatic purchase order generation tracking and organization for a company 12. The outage tooling service is in electronic communication with the company through email, a local-area-network of computers, a wide-area-network coupled to the Internet 14, and/or through direct computer network links 16. Within the company 12 are a requester 18, such as an engineering department, and a buyer 20. The requester and buyer are linked by a company computer network 22, which includes the computer hardware, software and databases that support the outage tooling service. The requester and buyer electronically communicate with the outage tooling service by email and the Internet 14, and further by linking to common shared database files on the computer network 22.

The outage tooling service system 10 may also communicate with vendors by emailing messages from the outage tooling service 10 by the Internet 14 to vendor computer systems 24. However, it is also envisioned that the vendors may communicate with the company by accessing a secure Internet website maintained by the company that provides procurement information to authorized users. Accordingly, the screen displays shown here may be presented by a website, as well as a client-application.

The outage tooling service is run on a computer system 22 having processor (such as a server on the network), memory to support databases, input and output devices such as workstations having screened displays and communication devices, such as modem for telephone connections. Supporting software systems for the outage tooling service are conventional database management, such as Microsoft Access 97, and operating systems, such as Microsoft Windows NT4.0. The OTS may also include an active messaging software application, such as Microsoft Outlook™ and Exchange™ email applications, to enable all individuals having access in the OTS system to be kept apprised as to the status of a particular purchase order.

Software data compression algorithms, such as PKZIP, can be used for compressing electronic drawing files and other large electronic documents which can be compressed for transmission via email or downloaded from a company website associated with the OTS. In addition, the OTS may include a company website through which the requesters, reviewers/buyers and vendors may access P.O. records, tool drawings, request for quotations and other purchasing information. The website may be secure and provide restricted access to only authorized persons. For example, the reviewers/buyers may have access to all data in the OTS, the requesters may only have access to the tool orders relevant to their particular job assignments, and the vendors may only have access to P.O.s (and associated tool drawings) that have been awarded to that vendor and to requests for quotations for which the vendor has been requested to bid on.

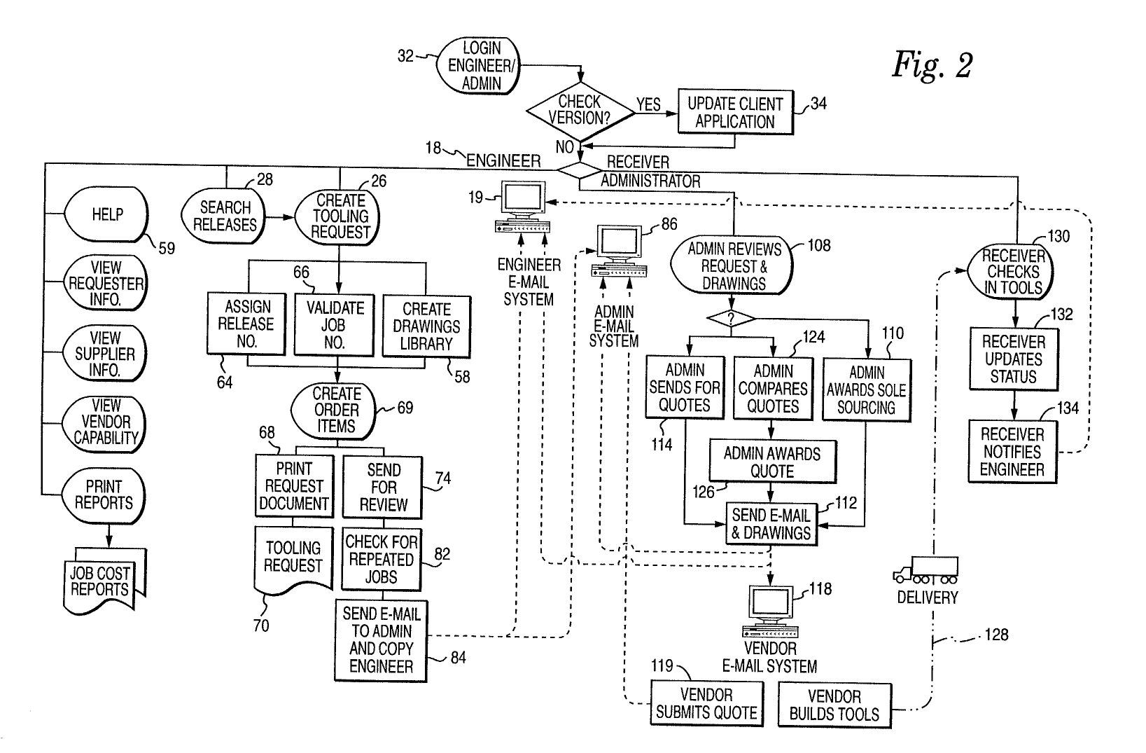

The OTS may be implemented as a simple, two-tier client-server system. Clients, e.g., work stations 19, 86 (FIG. 2) for the buyer 20 and requester 18, may have an OTS application implemented in, e.g., Visual Basic 6.0 as a first tier, client software application.

These client software applications communicate with a network resident OTS relational database, and with databases and directories storing tooling drawings and other information pertinent to the procurement process. The databases include data on pending and prior tool orders, quote requests and P.O.s; electronic folders of tool drawings; information on vendors (e.g., their names, address, contacts, tool fabrication capabilities, charge rates, and prior performance in fabricating tools); authorization and OTS access information regarding individual requesters and buyers; and other information pertinent to the tool requisitioning process.

The outage tooling service 10 performs several functions to automate the requisitioning and procurement of custom made products and services, such as machine tooling. For example, the outage tooling system provides automated tool order, quote request and purchase order generation and tracking. The OTS assists requesters and buyers to automatically generate tool orders, quote requests and purchase orders by presenting via a computer screen a sequence of screen displays that lead the buyer and requester through the process of generating these documents. These screen displays are templates stored on the outage tooling service database. The screen templates replace many of the paper forms previously used to prepare tooling requests. In addition, the screen template documents enable the requester or buyer to access the OTS database for information regarding vendors, prior tooling requests, and drawing files having electronic copies of tool drawings. The OTS automatically assigns purchase order numbers and generates email to distribute purchase orders for bids to vendors (via the vendor computer systems 24) and to regularly inform the buyer and requester of the status of pending purchase orders.

Within the company 12, the requester 18 initiates the generation of a tool request by the outage tooling service when he has a need for a new tool. If a new tool design is being procured, the requester first must draw the tool in an engineering format such that the tool may be made from the drawings and/or other specifications. If the tool had been previously fabricated, the requester may use an existing drawing of the tool that had been previously fabricated. Such tool drawings are available on databases linked to the OTS databases. Once the requester has drawings for the tool, the requester may access the OTS computer system and step through the screen displays presented by the OTS to generate a purchase order.

The buyer 20 receives the purchase order tool request from the requester. The buyer reviews the purchase orders, adds additional information, and approves the issuance of a purchase order. The purchase order includes an electronic link(s) to the tool drawings and specification. The buyer may also select vendors, from a database list of vendors maintained by the OTS, to receive the purchase order. The buyer distributes the purchase order electronically to the selected vendors for bidding. Alternatively, the buyer may determine that competitive bidding is not needed and issue the purchase order to one selected vendor for a sole-source procurement. The selected vendor, whether by sole-source procurement or competitive bidding, is then notified by the buyer that the vendor has been assigned to manufacture the tool. The buyer tracks performance of the vendor by insuring the vendor complies with the deadlines imposed by the purchase order and delivers the tool on time. Once the tool has been delivered and is deemed acceptable by the requester, the buyer may approve payment to the vendor of the tool.

The vendors receive requests for quotations and purchase orders at their own computers via email or by accessing an Internet OTS website operated by the company. These vendor computers may be located at the vendor site or may be portable computers which travel with the vendor and are accessible to the Internet. Upon receiving a purchase order, the vendor may elect to respond to the purchase order by bidding on the tool fabrication contract set forth in the purchase order. If the vendor chooses to respond, the response with the bid quote and any other information the vendor is required to submit to respond to the purchase order are electronically transmitted via email to the buyer. The vendor selected by the buyer to build the tool is notified by email or other means. The vendor may also acknowledge receipt of the purchase order by emailing a message to the OTS (and hence buyer and requester) or by accessing the OTS website.

The selected vendor fabricates the tool and delivers it to the company. While fabricating the tool, the vendor may communicate with the requester or buyer at the company via email to pose questions regarding the tool fabrication or to inform the buyer and requester of delays or other activities pertinent to the procurement. Moreover, the vendor may be electronically paid by electronic bank transfer from the buyer to the vendor.

FIG. 2 is a schematic of the process steps performed by the outage tooling system. In the log-in step 32, the engineer or buyer (the “requester”) enters via a computer workstation 19 the OTS system by entering a log-in identification that identifies the individual requester, and authenticates the requester's rights to access to the OTS system. This log-on process may also involve having the client application on the computer 19 of the engineer or buyer to confirm that the client application installed on the client workstation 19 is a current version of the OTS client application. If the client application is not current, then the log-in process will involve updating, step 34, the software application on the engineer's or buyer's computer workstation 19. Once a current client software application is executing on the workstation, the purchase order generation and tracking operation commences.

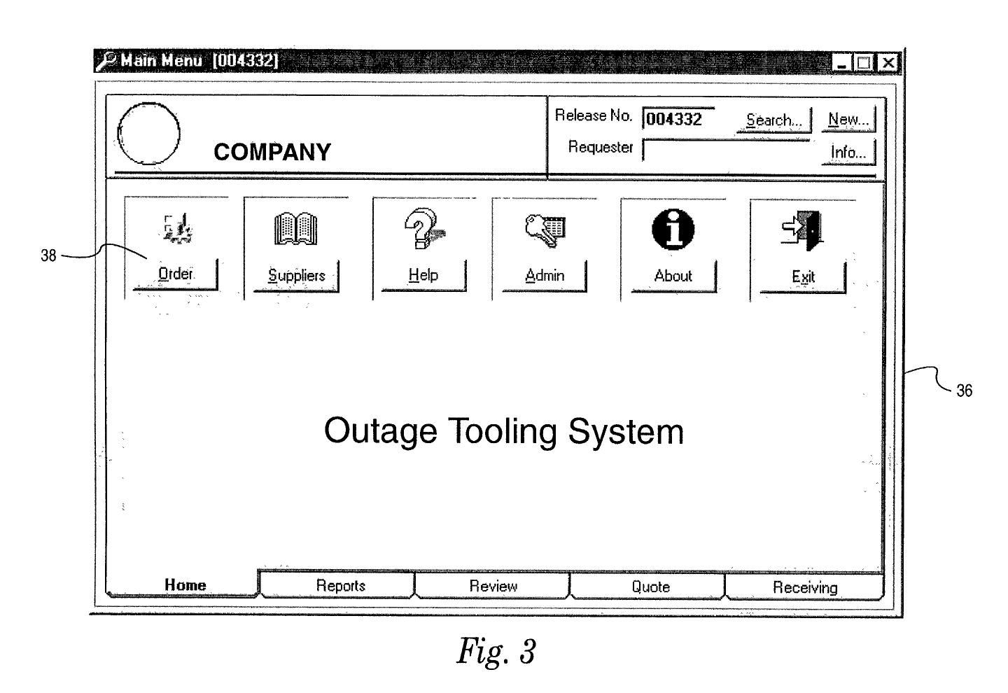

FIG. 3 shows an exemplary first main OTS screen menu 36 which is displayed on the computer screen of the workstation 19 of the engineer (requester) 18 who has initiated the OTS procurement application. The main menu 36 enables the requester or buyer to access the OTS system. The main menu allows the requester to select which process or information from the OTS is desired. For example, the engineer may activate the order screen key 38 to begin preparation of a custom order request, such as for a tooling request. As indicated in FIG. 2, the creation of a tool request begins with the option of creating a new tooling request, in step 26, or a search for prior request, step 28, of the same tool.

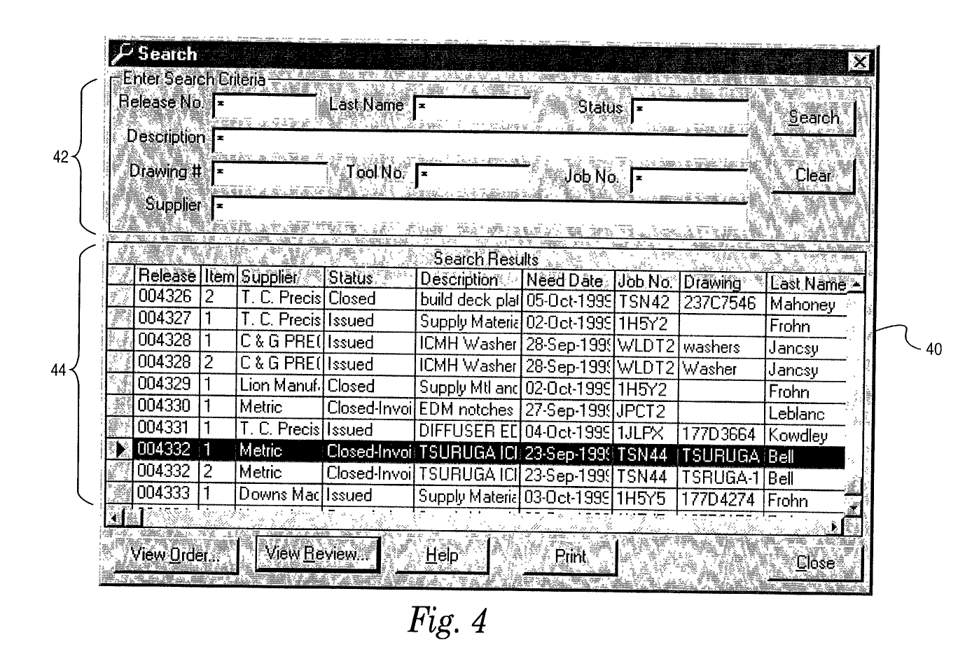

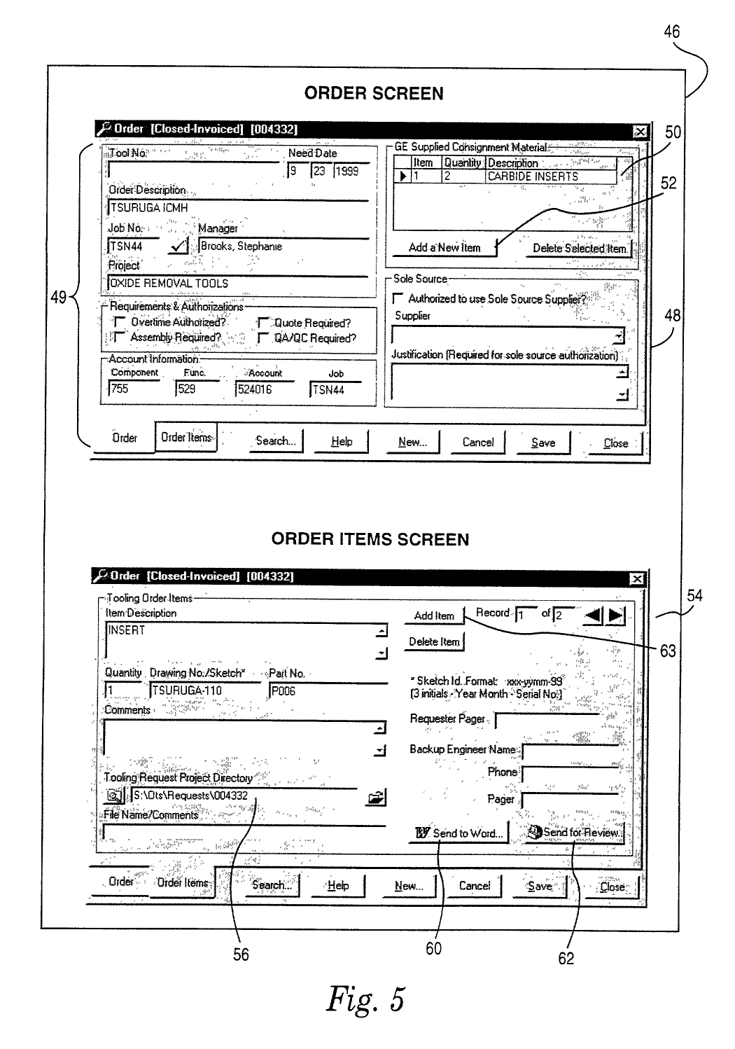

If the request is for manufacturing of an existing tool, step 28, then the OTS system displays a search screen such as shown in FIG. 4. The search screen 40 has a search criteria field 42 that includes several different parameters by which a search may be made of prior tool requests. For example, the search may be made by tool number, tool drawing number, tool name or description, tool fabricating vendor or supplier, name of requester, release number or purchase order for tool, or status of purchase order. This search template is not limited to finding prior tool orders for creating a new purchase order for a duplicate tool. Rather, the search may be used to query the OTS system for a variety of purposes such as to audit procurements, and obtain reports of tooling costs, tooling vendors and of tooling requesters.

Once the search is completed, the search screen 40 displays the search results in field 44. The search results are organized in an electronic spread sheet or database manner to show various types of information such as purchase order release, vendor, purchase order status, tool description, delivery date, e.g., “need date”, job number to which the tool cost is to be charged, tool drawing and requester name. A category may also be included as to item to refer to purchase orders having multiple items to be fabricated. The search results may be viewed, and printed. For example, if the requester has asked for prior purchase orders of a tool that had been previously fabricated, then the search will display those prior purchase orders for that tool.

FIG. 5 shows a pair of tool request order screen templates 46 for generating a new purchase order. The screen templates may be displayed sequentially as the requester enters the data into the screen templates to generate the purchase order. The first tool request screen template 48 has tool request database fields 49 for filling out information such as tool number, order description, tool job number, name of manager, project name, delivery date (need date), accounting information and authorizations for various matters such as overtime, bidding and other issues. In addition, in tool identification data field 50 is entered the identification of consigned material to vendor in the purchase order.

The accounting information, e.g., charge number, is verified by the OTS system through a database job search. If the charge number is incorrect, the OTS system warns the requestor that the number is not valid. A valid charge number is needed by the OTS to continue processing the tool request.

The requester may activate a “add item” screen button 63 to switch to the second order item screen 54 for identifying a tool to be ordered. The second screen 54 may be also accessed by activating the electronic tab “order items” towards the bottom of the screen template 48, 54. The order items screen template 54 has several data fields for entering information defining the tool to be ordered such as tool description, quantity of tools to be ordered, tool drawing sketch and part number and comments regarding the tool that would be useful for the vendor in manufacturing the tool.

In tool drawing storage location data field 56, the screen display lists electronic file paths to the purchase order that is stored on the OTS database. This tool drawing file path 56 identifies a location, e.g., electronic storage folder, on the OTS databases for storing the purchase order and drawing numbers. The file location is automatically created by OTS as an electronic library for the purchase order and drawing number, as is shown in FIG. 2 in step 58. Upon completing the entries for the tool request another direct link icon (SEND TO WORD 60) sends the request information from the ORDER and ORDER ITEMS screens 46 to a MS Word document for printing or saving. If the changes were not saved a prompt reminds the user to save the changes. If drawings were not entered another warning prompt will be displayed. To inform the OTS reviewer/buyer that the tool request job is ready to process, a direct link key (SEND FOR REVIEW 62) is depressed to automatically create an e-mail (see FIG. 8) to forward the tool job request to a buyer/reviewer. When the e-mail is sent, the OTS system locks the requestor out and does not allow further changes to the order. The system changes the tool order status to “review” so as to indicate to a reviewer/buyer that a tool order is ready to be incorporated into a quotation request to be sent to tooling vendors. In addition, the requester entering the information requested by the purchase order screen templates may obtain assistance using a help button on the screen templates to access text and other information (59 in FIG. 2) to assist in completing the purchase order request, and may activate other buttons to cancel the purchase order request, save the purchase order request for later completion, or for creating a new purchase order request, searching for other purchase orders within the database.

In operation, an engineer or technician (the “requester”) in need of new tool logs on to the OTS using a password that may be unique to that engineer/technican. This password protects the integrity of the data being entered by limiting rights to add or modify data in the OTS to only those persons having a need to enter data. Once logged-in the OTS system, the requester creates a “new” release for a tool order using the screen templates shown in FIG. 5. The requester enters a unique identification number for the tool (which may be used by the requestor's business group to identify the tool). The OTS system automatically assigns a tracking number for the tool job and creates a directory in the OTS database to store the tool drawings and specification. In addition, the OTS designates the status of the tool job, i.e., “order status” as being “OPEN”.

Once the data needed for preparing a tool request is entered by the requester in the screen templates 46, the OTS system assigns a release number to the purchase order in step 64 (FIG. 2) and confirms that a valid job number has been assigned to the purchase order request in step 66. Assignment of release numbers to the purchase order may be done sequentially by the OTS system and the validation job numbers may be done by having the OTS system access other databases within the company to confirm that a valid job number has been entered.

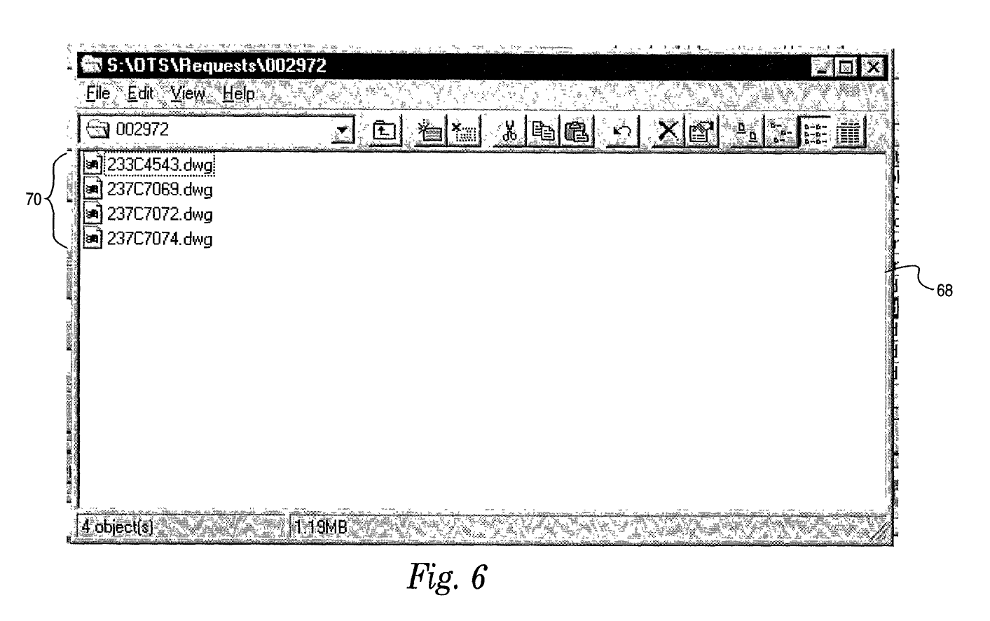

The OTS system automatically generates a proposed tool request, in step 69 of FIG. 2. The OTS assigns a release number, confirms the validity of the job number; confirms that an authorization has been given to the purchaser order by a manager, and, assigns a default delivery date for the purchase order (if one has not been manually entered by the requester). In addition, the OTS automatically creates a drawings library (step 58), e.g., electronic folder, in its databases for the tool drawings. The electronic path to the drawing library is automatically inserted in the data field 56 for the project directory. This tool drawing file directory may be displayed for review by requesting a tool drawing screen 68 (as shown in FIG. 6) which is unique for each tool order request. The tool drawings are identified by their electronic drawing names 70 in a list on the file directory. Accordingly, the OTS system automatically creates a unique file folder 58 (screen 68) for each tool order to store tool drawings which are used in generating purchase orders and maintaining records regarding the tool.

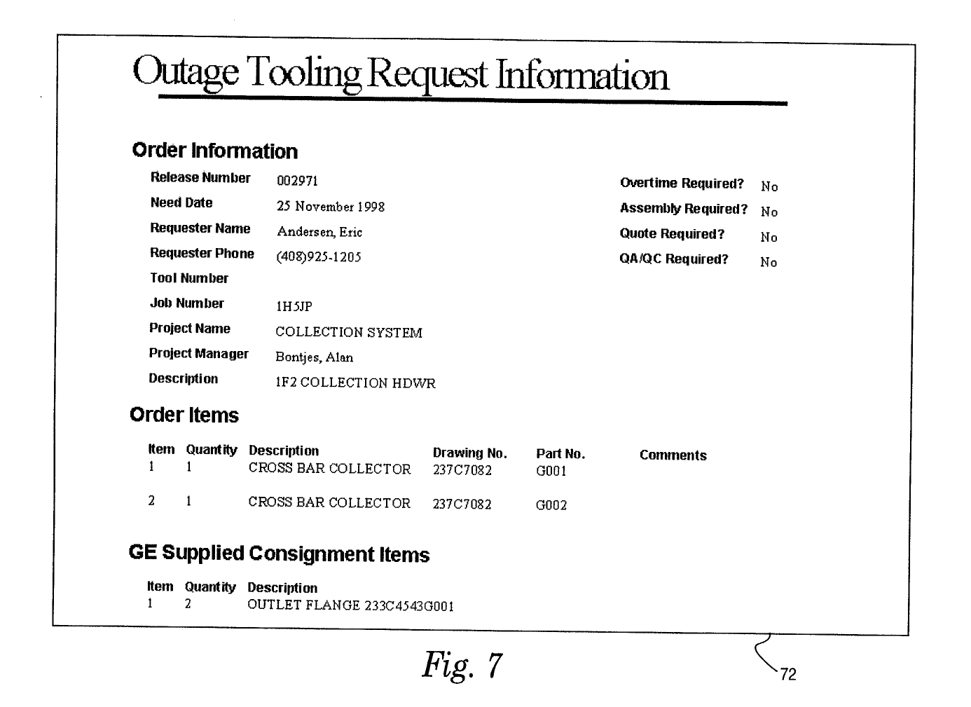

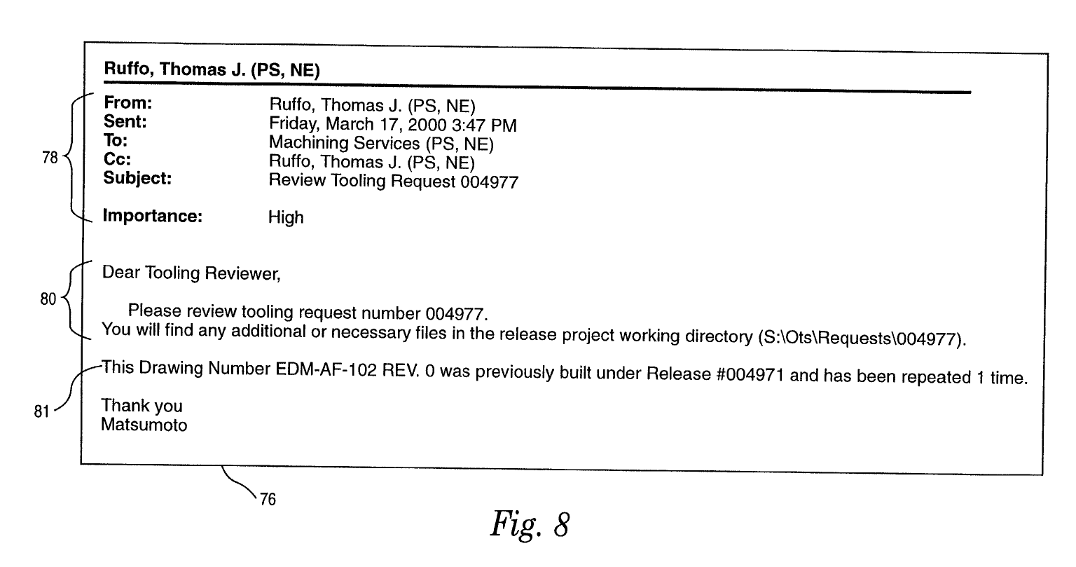

FIG. 7 shows an exemplary printable document 72 generated by the OTS (steps 68 and 70 in FIG. 2) based on the purchase order request entered in the purchase order screens 46. This document 72 shows in a convenient word processing format the proposed purchase order for review and revision by the requester. The document may be saved in the paper records by the requester.

The proposed tool request is sent for review (step 74 in FIG. 2) by activating the review button 62, the OTS automatically generates an email message (FIG. 8) to a buyer containing the information for the proposed tool order. The OTS email message 76 indicates that the order is ready for processing and approval. The email message 76 may be in a conventional email format, such as Microsoft Outlook™, and include an addressing section 78 identifying the addresser and previously built orders (81), e.g., the requester; the addresser, e.g., the reviewer; and a subject line.

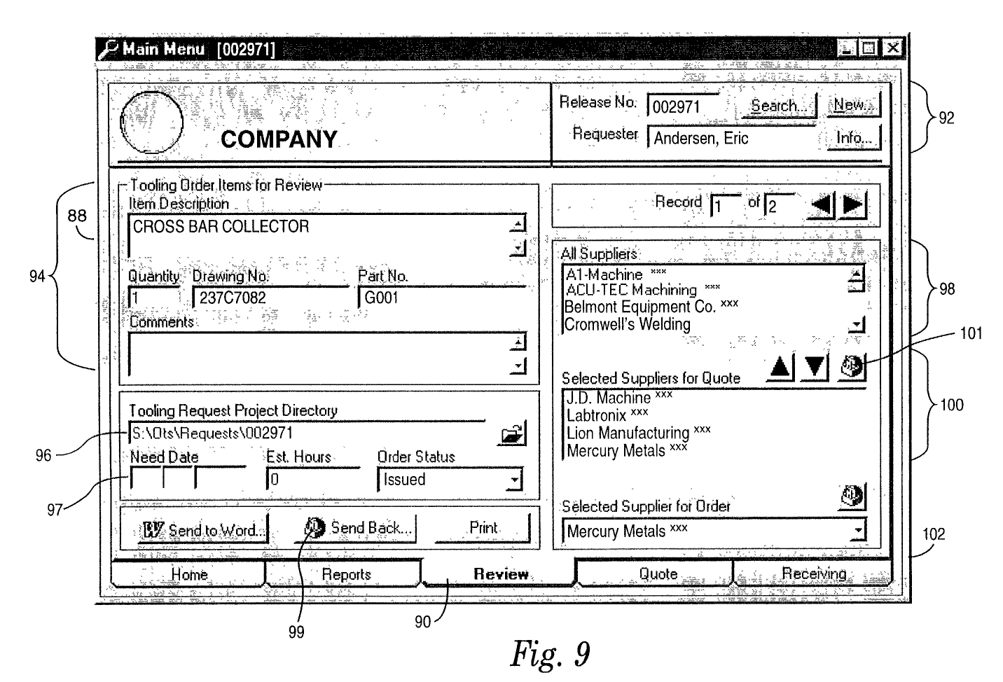

The buyer/reviewer logs into the OTS system with their own password that provides more access to the system than was afforded to the requester. Using the review screen (FIG. 9) the buyer/reviewer buyer evaluates the tool requirements, date by which the tool is to be delivered, tool drawing complexity, and capability of prospective vendors. Based on the complexity and the need date, the reviewer can issue a tool quote request to a single selected vendor (e.g., a sole-source-contract) or select a group of vendors for competative bids on the tool.

A direct link emaill icon 101 on the review screen (FIG. 9) configures the tool request data entered in by the requestor via the order and order item screens 46, and a software sub-routine opens the database file directory where the tool drawings are stored and compresses the drawings into a self extracting zip electronic file. The OTS system attaches the zip file of the tool drawings to an email for sending to the vendor(s) who are to submit quotations on the tool. Another sub-routine then identifies the vendors selected to receive the quote request, accesses the supplier database and copies the vendor's e-mail address into the email message. The OTS sytem then formats the e-mail message for delivery with a copy of the message being sent to the buyer/reviewer. If the order is being quoted only, a separate e-mail is created for each of the selected vendors. A separate e-mail is also created that informs the requester of the progress of the order. The e-mail includes the vendor's name that the order was issued to or a list of vendors for quote with a required response date and time.

The OTS system may automatically identify and insert the email address for the reviewer and create a subject line that denotes the message as a “Review Tooling Request” and identifies the request number. In addition, the email message may be automatically time and date stamped for record purposes. The text section 80 of the email tooling review message 76 may include a simple request to a review a particular tooling request having a certain number (see 64 in FIG. 2); identifying the working file (see 58 in FIG. 2) where the information for the tooling request is stored in the OTS databases, and the requester's name.

In addition, the OTS automatically checks whether the tool requested by the purchase order is a duplicate tool of one previously manufactured, step 82 in FIG. 2 (FIG. 8, Item 81). If a repeat tool manufacturing job is requested, the OTS will notify the requester and the buyer that the tool had been previously ordered and delivered. This information of repeated tool requests may be useful in locating an existing tool which may satisfy the requester's need without having to fabricate an additional tool, and may inform the buyer of vendor(s) who previously fabricated the tool.

The email message requesting a tool order review 76 (FIG. 8) is sent to the reviewer identified as the addressee (“To:”) in the indentifier section 78 of the message and copied to the originiating requester, in step 84. In addition, the OTS system designates the purchase order as having an “open” status. The reviewer opens the email message 76 at the reviewer's computer workstation 86 and accesses the request on the OTS system by entering the tooling request reference number idnetified in the message.

FIG. 9 is an exemplary review screen template 88 presented by the OTS system to reviewers of tooling requests. The screen template has a tab 90 which allows for the review of tooling requests. Other tabs enable the reviewer to view quotes submitted by vendors to issued purchase orders, listings of completed tool orders which have been delievered by the vendors, generate reports from the OTS database, and a home page for the OTS system. The “review” tab calls-up the screen shown in FIG. 9 which is useful for reviewing tooling requests and generating purchase orders.

The review screen 88 includes a search and retrieve section 92 that allows for searches based on tool request number (see 26 in FIG. 2) and/or the requester's name. Once a particular tool request has been found, the OTS system retrives information regarding the request and presents tooling information in the review screen 88, such as the name, part number and drawing number for the tool, and the quantity of tools to be procured, in data field section 94. The review screen also includes tool drawing path sections 96 that identify the database path to the tooling project directory (where there is stored tool drawings and other tool specifications), and a need date data field 97 request date data field that states the date by which the tool is needed for delievery (which may be a default date such as two-weeks from the P.O. issuance date), the estimated number of hours needed to fabricate the tool and the status of the P.O., e.g., open, out-for-quote, awarded, and completed.

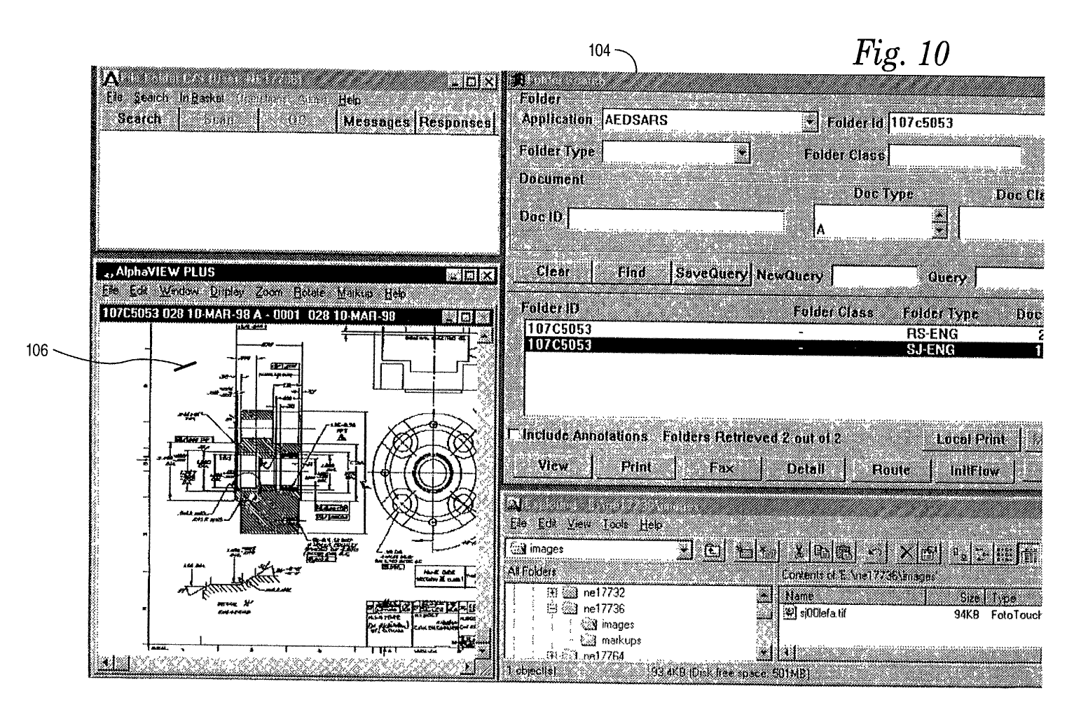

The reviewer has access via the OTS to a complete file on the tool that is the subject of the request. The reviewer may access the project directory via a directory folder search and view the tooling drawings using a veiwer program shown in FIG. 10. In addition, the reviewer may send an email message back to the requester via buttom 99 to clarify an issue regarding the tooling request, to obtain additional information regarding the request, or to inquire as to whether an existing tool would satisfy the requester's needs.

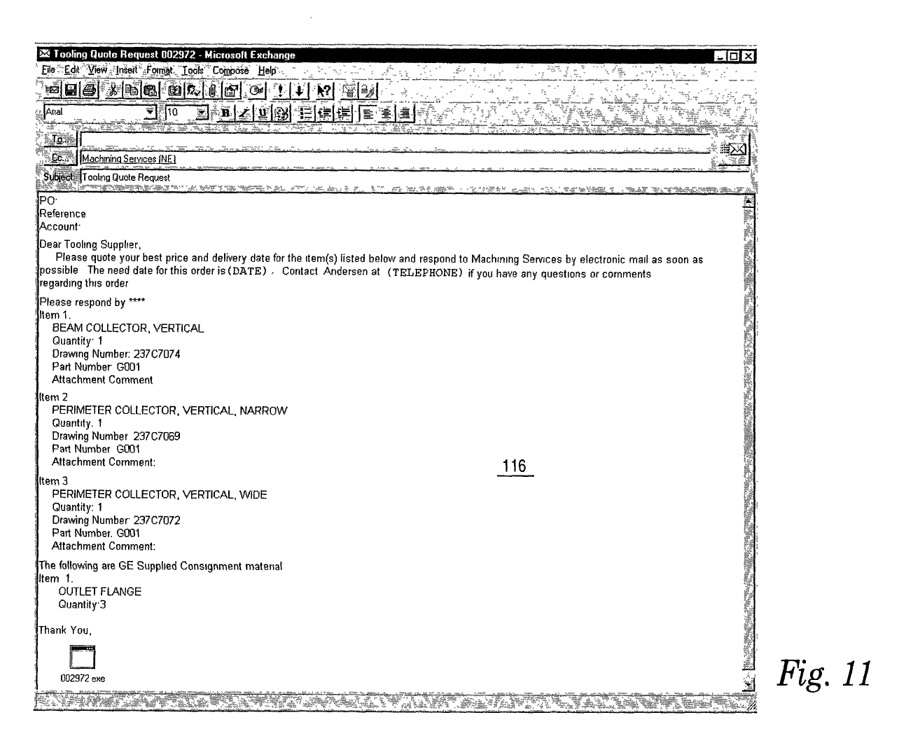

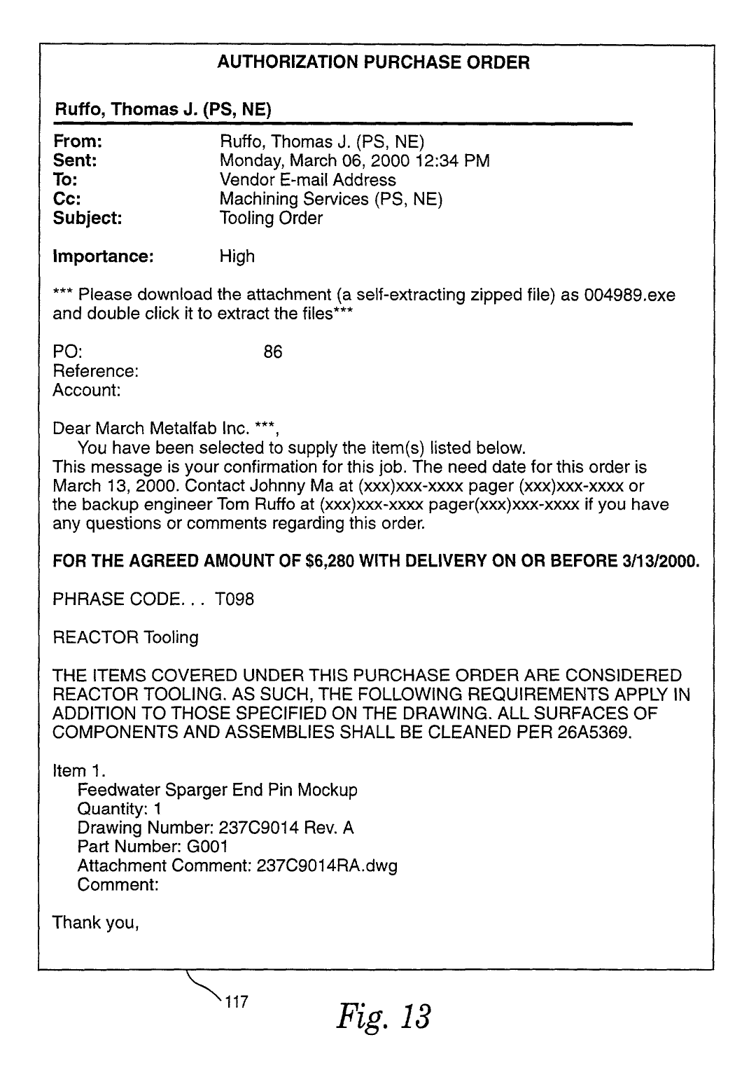

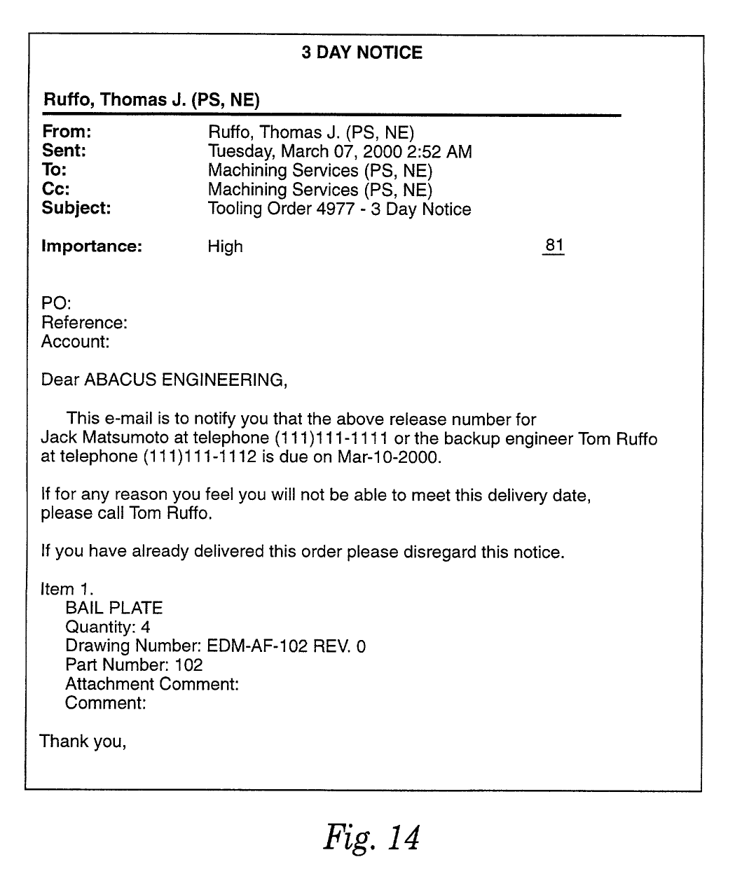

The reviewer approves the tooling request (step 108 in FIG. 2) and, thus, must select one or more vendors to solicit for fabrication of the tool. The OTS presents the reviewer with a listing of all authorized vendors (screen section 98). The reviewer scrolls and selects the one or more vendors for inclusion in a list of vendors to receive a quote request (screen section 100). If the qoute request is to be a sole-source procurement, (step 110 in FIG. 2), the reviewer selects the one-selected vendor (102) and the OTS system automatically generates an authorization email message (117 FIG. 13) to the vendor. If the quote is to be issued for competative bid, then the reviewer selects the plurality of vendors to receive the same quote request message (step 114 in 116, FIG. 11).

An exemplary email quote request 116 is shown in FIG. 11, and includes the email addresses of the reviewer and supplier, a written quote request for tooling, that may be identified by P.O. release number, name, quantity, part number and supplied parts. A quote request may identify multiple tool orders on which quotations are being requested. In addition, the message may identify the engineer requesting the tool, and the date by which the tool is to be delieverd. The quote message 116 may also include an electronic copy of the tool drawings and other tool specifications (which may be electronically compressed, such as with a self-extracting zip compression program). Separate email messages are send simultaneoulsy to each of the selected suppliers to bid on the tool request, in step 112. The vendors receive the quote message 116 via the Internet on their own computer systems 118.

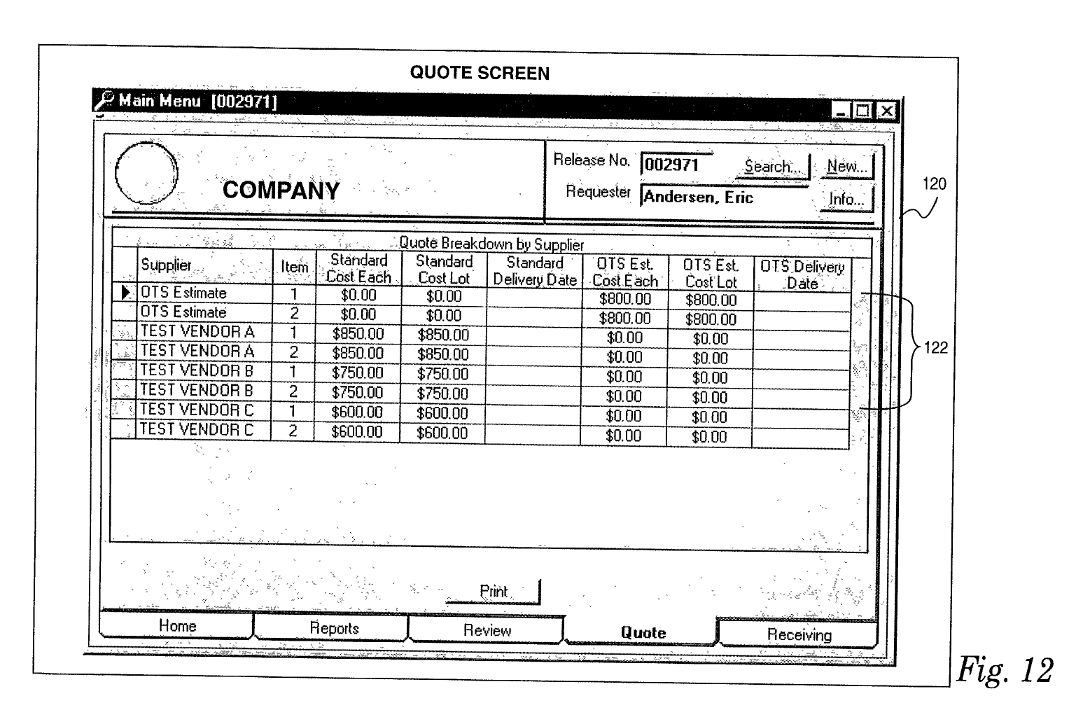

The selected vendor(s) respond to the quote message 116 by sending an email quotation message (119) to the reviewer or buyer (at computer 86). As the quotations are received, the buyer/reviewer enters the quotes into the OTS system via a quotation evaluation screen template 120 shown in FIG. 12. The template 120 may be accessed by activating the “quote” tab on the reviewer's display (where the screen for the “review” tab is shown in FIG. 9 and the screen for the “home” tab is shown in FIG. 3). The quote template 120 may include data fields 122 for the name of the supplier, the item(s) on which the supplier bid (where the items were identified for bid in the email quote message 116), the standard delievery cost quoted by the supplier for the item (as well as the cost quote for the lot if more than one of the item is to be procured), the standard delievery date for the item.

The reviewer/buyer can easily select (step 124) the lowest cost bid for each item from the list of qualified quotations entered in the quote screen 120. This selection may be made after the end of the bid period (which period was stated in the request for quotation message 116). The successful bidder/supplier for each item is notified via email that its bid was accepted, and that it has a contractual purchase order (P.O.) to fabricate and deliever a tool to the company, in step 126 (FIG. 13). A copy of the P.O. message may also be sent to the original requester of the tool. The status of the P.O. is changed in the OTS system to “issued”. The OTS system may include a calendering software application that tracks the delivery dates for awarded P.O. and the system can be configured to automatically issue email message to the reviewer, requester and/or supplier if a tool is not delivered on time.

When the vendor completes fabrication of the tool and delievers it to the company (step 128), a receiver for the company checks the tool to confirm that the tool conforms to the tool drawings and specifications stated in the P.O. (step 130). The receiver may access the OTS to review the tool drawings and specification, and compare these documents to the delivered tool. Assuming that the tool is satisfactory, the receiver updates the status of the tool in the OTS as having been delievered. The OTS automatically dockets the tool as having been delievered, notes whether the supplier timely delievered the tool, and sends email messages to the requester and/or reviewer to notify them of the arriaval of the tool (steps 132 and 134).

The OTS system has a variety of report generation capabilities, including locating the requesters and tooling numbers for previously fabricated tools; listing prior tool orders awarded to and/or completed by specific vendors, by cost, by requestor, and by other parameters; listing tool orders completed by specific vendors. For example, entering the 5-digit charge number will generate a report that lists all of the jobs that were built under that number. It will include the requester, a description, the tracking number, how many parts were ordered and the invoiced amount. This report can be modified, sorted, and dollars totaled up. Since the data resides in an Microsoft Access™ database, other specialized reports can easily be generated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for requisitioning a custom made product using a requester computer, reviewer computer and a vendor computer each being in electronic communication with each other, and the requester computer and reviewer computer having access to a central computer system including a requisition database, wherein the method comprises steps of:
a. forming a custom product request by entering product data into the requisitioning database via the requester computer, wherein the product data includes product specification information sufficient to fabricate the product;
b. storing the product data in a unique file location in or linked to the requisitioning database;
c. generating a request for quotation to fabricate the product, wherein the request includes an electronic copy of the product data obtained by automatically linking to the unique file location having the product data;
d. electronically sending the request for quotation to at least one vendor able to fabricate the product;
e. entering quotation information in said requisitioning database upon receipt of a response by the at least one vendor to the request for quotation, and
f. electronically issuing a purchase order to a selected vendor of at least one vendor responding to the request for quotation.

2. A method for requisitioning a custom made product as in claim 1 wherein in step (d) the request for quotation is sent to a group of vendors, and in step (e) quotation information is entered in the requisitioning database for each vendor of the group of vendors that responds to the request for quotation, and further comprising step (g) of selecting a responding vendors to receive a purchase order based on the information in the requisitioning database.

3. A method for requisitioning a custom made product as in claim 1 wherein in step (d) the request for quotations is send by electronic mail over the Internet and in step (f) the issuance of the purchase order is sent by electronic mail over the Internet to the selected vendor.

4. A method for requisitioning a custom made product as in claim 2 wherein in step (e) a price quoted by each the responding vendors is entered in the requisitioning database, and in step (g) the selection of the vendor is based on lowest price quoted.

5. A method for requisitioning a custom made product as in claim 1 wherein the custom made product is a tool, the product data includes drawings of the tool and in step (d) the request for quotation is sent with an electronic copy of the drawings.

6. A system for requisitioning a custom made product comprising:
a requestor computer including a processor, memory, a requester input and display, wherein said processor and memory store a client-software application which generates a display image prompting a requestor to enter a product request order and automatically generating an electronic product request message containing product data;
a reviewer computer having a processor, memory and a reviewer input and display, and in electronic communication with the requester computer, said review computer memory storing a client-software application having executable algorithms for capturing product data from the product request message, generating a display image to prompt a requester to select one or more vendors to bid on a quotation request, automatically generating the quotation request with the product data, and electronically sending the quotation request to the one or more vendors;
a central computer system including a requisition database storing product data corresponding to the product request, and
a vendor computer in electronic communication with the reviewer computer.
